(19) United States
(12) Patent Application Publication
(10) Pub. No.: US 2016/0049082 A1
(43) Pub. Date: Feb. 18, 2016

(54) System for Interactive Online Instruction

(71) Applicant: Albert Roy Leatherman, III, Annapolis, MD (US)

(72) Inventor: Albert Roy Leatherman, III, Annapolis, MD (US)

(21) Appl. No.: 14/621,943

(22) Filed: Feb. 13, 2015

Related U.S. Application Data
(60) Provisional application No. 62/037,473, filed on Aug. 14, 2014.

(51) Int. Cl. G09B 5/06; H04N 7/15

(52) U.S. Cl. CPC G09B 5/06; H04N 7/15

(57) ABSTRACT

Remote collaboration, particularly synchronous collaboration, between parties in separate locations can be enhanced by providing the opportunity for both parties to “write” on a paper medium or other surface. This is particularly useful in an instructor/student tutoring session. Both the student and instructor may have workstations with video conferencing and screen-sharing capabilities. Advantageously the student station has a camera such as a document camera for imaging an object that the student may write on, for example, writing on paper with a pen. The instructor station may have an interactive whiteboard and a projector. Video conferencing capabilities are used to transmit an image of the student writing to the instructor which image will be displayed to the instructor through projection onto an interactive whiteboard surface. The interactive whiteboard allows the instructor to “virtually” mark the projection of the paper using for example a stylus and an infrared sensor. Annotation software at the instructor's station creates a representation of the instructor's “writing.” The annotation software also may add the representation of the writing to the instructor's projection. The representation of the writing and the representation of the image are provided to the student station by the screen-sharing software and the combined document image and annotations may be displayed to the student creating the effect of the remote instructor writing on a paper locally imaged by the document station.

This application claims priority from and the benefit of the filing date of application No. 62/037,473 filed Aug. 14, 2014, the disclosure of which is incorporated herein.

### BACKGROUND OF THE INVENTION

1. Field of the Invention

The present invention relates to educational technology and more particularly, to distance learning. More particularly, the present invention is in the technical field of live interactive distance learning.

2. Description of the Prior Art

Educational technology is the effective use of technological tools in learning. An array of tools, such as media, machines and networking hardware has been applied to educational objectives.

Electronic educational technology has become an important part of society today. Educational technology includes (and is broadly synonymous with) e-learning, instructional technology, information and communication technology (ICT) in education, EdTech, learning technology, multimedia learning, technology-enhanced learning (TEL), computer-based instruction (CBI), computer managed instruction, computer-based training (CBT), computer-assisted instruction or computer-aided instruction (CAI), internet-based training (IBT), flexible learning, web-based training (WBT), online education, virtual education, personal learning environments, networked learning, virtual learning environments (VLE) (which are also called learning platforms), m-learning, and digital education. These labels have been variously used and understood, and conflate to the broad domain of educational technology and e-learning. These descriptive terms individually emphasize a particular digitization approach, component or delivery method.

Theoretical perspectives and scientific testing may influence instructional design. The application of theories of human behavior to educational technology derives input from instructional theory, learning theory, educational psychology, media psychology and human performance technology.

Educational technology includes numerous types of media that deliver text, audio, images, animation, and streaming video, and includes technology applications and processes such as audio or video tape, satellite TV, CD-ROM, and computer-based learning, as well as local intranet/extranet and web-based learning. Information and communication systems, whether free-standing or based on either local networks or the Internet in networked learning, underlie many e-learning processes.

Educational technology and e-learning can occur in or out of the classroom. It can be self-paced, asynchronous learning or may be instructor-led, synchronous learning. It is suited to distance learning and in conjunction with face-to-face teaching, which is termed blended learning. Educational technology is used by learners and educators in homes, schools (both K-12 and higher education), businesses, and other settings.

Virtual learning in a narrowly defined semantic sense implies entering the environmental simulation within a virtual world. A virtual education course refers to any instructional course in which all, or at least a significant portion, of the course is delivered by the Internet. “Virtual” is used in that broader way to describe a course that is taught not in a classroom face-to-face but through a substitute mode that can conceptually be associated “virtually” with classroom teaching, which means that people do not have to go to the physical classroom to learn. Accordingly, virtual education refers to a form of distance learning in which course content is delivered by various methods such as course management applications, multimedia resources, and videoconferencing. Students and instructors communicate via these technologies.

Early e-learning systems, based on computer-based learning/training often replicated autocratic teaching styles whereby the role of the e-learning system was assumed to be for transferring knowledge, as opposed to systems developed later based on computer-supported collaborative learning (CSCL), which encouraged the shared development of knowledge.

Videoconferencing was an important forerunner of the educational technologies known today. Disadvantages of this form of educational technology are readily apparent: image and sound quality is often grainy or pixilated; videoconferencing requires setting up a type of mini-television studio for broadcast, space becomes an issue; and specialized equipment is required for both the provider and the participant.

Due in part to technical advancements in low cost hardware and network access bandwidth, online education is rapidly increasing and is becoming as viable an alternative as traditional classrooms. According to a 2008 study conducted by the U.S Department of Education, during the 2006-2007 academic year about 66% of postsecondary public and private schools participating in student financial aid programs offered some distance learning courses. In 2008, the Council of Europe passed a statement endorsing e-learning's potential to drive equality and education improvements across the EU.

Today, the prevailing paradigm is computer-mediated communication (CMC), in which the primary interaction is between learners and instructors, mediated by the computer. Computer Based Training relies on individualized (self-study) learning, while CMC involves educator/tutor facilitation and requires scenarization of flexible learning activities. In addition, current information and communications technology may provide educators with tools for sustaining learning communities and associated knowledge management tasks.

Students growing up in this digital age have extensive exposure to a variety of media. Major high-tech companies such as Google, Verizon, and Microsoft are funding schools to provide them the ability to teach their students through technology, which may lead to improved student performance.

E-learning may be either synchronous or asynchronous. Synchronous learning occurs in real-time, with all participants interacting at the same time, while asynchronous learning is self-paced and allows participants to engage in the exchange of ideas or information without the dependency of other participants' involvement at the same time.

Synchronous learning refers to the exchange of ideas and information with one or more participants during the same period. Examples are face-to-face discussion, online real-time live teacher instruction and feedback, video conference conversations, and chat rooms or virtual classrooms where everyone is online and working collaboratively at the same time.

Asynchronous learning may use technologies such as email, blogs, wikis, and discussion boards, as well as web-supported textbooks, hypertext documents, audio video courses, and social networking using Web 2.0. At the professional educational level, training may include virtual operating rooms. Asynchronous learning is particularly beneficial for students who have health problems or have child care responsibilities if regularly leaving the home to attend lectures is difficult. They have the opportunity to complete their work in a low-stress environment and within a more flexible timeframe. In asynchronous online courses, students proceed at their own pace. If they need to listen to a lecture a second time, or think about a question for a while, they may do so without fearing that they will hold back the rest of the class. Through online courses, students can earn their diplomas more quickly, or repeat failed courses without the embarrassment of being in a class with younger students. Students have access to an incredible variety of enrichment courses in online learning, and can participate in college courses, internships, sports, or work and still graduate with their class.

Computer-supported collaborative learning (CSCL) uses instructional methods designed to encourage or require students to work together on learning tasks.

CSCL uses blogs, wikis, and cloud-based document portals (such as Google Docs and Dropbox). With technological advances, sharing information between multiple people in a network has become much easier and use has increased.

Locus of control remains an important consideration in successful engagement of e-learners. The continuing attention to aspects of motivation and success in regard to e-learning should be kept in context and concert with other educational efforts. Information about motivational tendencies can help educators, psychologists, and technologists develop insights to help students perform better academically.

Many conventional e-learning systems are based on instructional packets, which are delivered to students using assignments. Assignments may be evaluated by the teacher. More recently, e-learning systems have increased emphasis on social learning and use of social software such as blogs, wikis, podcasts and virtual worlds.

Education can be enhanced by collaboration and engagement. Educational collaboration has been effected through social networking such as Skype, Facebook, Instagram, etc.

Webcams and webcasting have been used in educational settings and enable creation of virtual classrooms and virtual learning environments. Likewise, interactive whiteboards and smartboards allow learners and instructors to write on the touch screen. The screen markup can be on either a blank whiteboard or any computer screen content. Depending on permission settings, this visual learning can be interactive and participatory, including writing and manipulating images on the interactive whiteboard.

Screencasting allows users to share their screens directly from their browser and make the video available online so that other viewers can stream the video directly. The presenter thus has the ability to show their ideas and flow of thoughts rather than simply explain them as simple text content. In combination with audio and video, the educator can mimic the one-on-one experience of the classroom and deliver clear, complete instructions. Learners may have an ability to pause and rewind, to review at their own pace, something a classroom cannot always offer.

Virtual Learning Environments, are used to simulate a virtual classroom or meetings by simultaneously mixing several communication technologies. For example, web conferencing software such as GoToTraining, WebEx Training or Adobe Connect may enable students and instructors to communicate with each other via webcam, microphone, and real-time chatting in a group setting. Participants can raise hands, answer polls or take tests. Students are able to whiteboard and screencast when given rights by the instructor, who sets permission levels for text notes, microphone rights and mouse control.

A virtual classroom provides an opportunity, albeit limited, for students to receive direct instruction from a qualified teacher in an interactive environment. Learners can have direct and immediate access to their instructor for instant feedback and direction. The virtual classroom provides a structured schedule of classes, which can be helpful for students who may find the freedom of asynchronous learning to be overwhelming. In addition, the virtual classroom provides a social learning environment that replicates the traditional “brick and mortar” classroom. Most virtual classroom applications provide a recording feature. Each class is recorded and stored on a server, which allows for instant playback of any class over the course of the school year. This can be extremely useful for students to review material and concepts for an upcoming exam. This provides students with the opportunity to watch any class that they may have missed, so that they do not fall behind. Parents and auditors have the conceptual ability to monitor any classroom to ensure that they are satisfied with the education the learner is receiving.

Internet-based learning management systems (LMS) include Canvas, Blackboard Inc. and Moodle. These types of LMS allow educators to run a learning system partially or fully online, asynchronously or synchronously. Blackboard and Eliademy are network-based, cloud-based Course Management Systems.

Benefits of incorporating technology into learning may include: improved open access to education, better integration for non-full-time students, and improved interactions between students and instructors, reduced travel costs, and easy-to-access course materials.

Although some aspects of a classroom setting are missed by using these resources, they are helpful tools to add additional support to the educational system.

Interactive whiteboards may use one of several types of sensing technology to track interaction on the screen surface: resistive, electromagnetic, infrared optical, laser, ultra-sonic, and camera-based (optical).

Resistive touchscreens may be composed of two flexible sheets coated with a resistive material and separated by a microthin air gap. When contact is made to the surface of the touchscreen, the two sheets are pressed together, registering the precise location of the touch. This technology allows one to use a finger, a stylus, or any other pointing device on the surface of the board.

Active Electromagnetic Board is a whiteboard that features an array of wires embedded behind the board surface that interacts with a coil in the stylus tip to determine the (X,Y) coordinate of the stylus. Styli are either active (require a battery or wire back to the whiteboard) or passive (alter electrical signals produced by the board, but contain no batteries or other power source). In other words, there are magnetic sensors in the board that react and send a message back to the computer when they are activated by a magnetic pen.

Passive Electromagnetic Boards do not contain the sensing technology in the board itself, but in the pen. Tiny magnetic fibers are embedded in the whiteboard and form a pattern that an electromagnetic coil in the pen is able to sense. Therefore the pen is able to calculate its location on the whiteboard and sends this information to a computer.

Capacitive whiteboards work with an array of wires behind the board. The wires interact with fingers touching a screen. The interaction between the different wires and the tip of the finger is measured and calculated to a (x, y) coordinate. Other types of whiteboards include Projected Capacitive, which uses an Indium Tin Oxide (ITO) grid sandwiched between clear film or Transparent Electrodes replacing the ITO. There are other white board technologies in use.

As described, existing tools allow online teachers to write on virtual whiteboards, transmit video images of their own writing on paper, chalkboards, or other media, and the like. Similarly, existing tools allow students in online classes to write on virtual whiteboards or to transmit video images of their own writing on paper, chalkboards, or other media. Existing tools, however, do not provide a way for teachers to write virtually on their pupil's (or pupils′) paper, meaning that online classes suffer from a relative inability of teachers and students to interact in real time on the same paper or in the same book as they would if they were working together in person.

### SUMMARY OF THE INVENTION

The prior art systems do not permit a remote virtual tutor or instructor to “write” on a student's paper. This aspect of live in-person tutoring or instruction is missed by use of remote conferencing and currently available interactive whiteboards or screen sharing.

It is an object of the invention to more accurately simulate live instruction using educational technology to facilitate remote instruction.

It is an object of the invention to simulate live tutoring, live instruction and live collaboration.

It is an object of the invention to simulate an instructor in a remote location writing on a paper at the student's location.

It is an object of the invention to provide an online instructional system for teachers, tutors, professors, or other instructors to use to write virtually on their pupil's (or pupils′) paper(s), book(s), or other physical media. According to an advantageous feature, the system may allow instructors and students to interact virtually on the same paper, book, or other physical medium, approximating the effect of writing on the same physical medium as might occur when instructor(s) and student(s) work together in person.

A virtual writing system for use in synchronous collaboration may be provided to allow a user to view an image of a document that may be written on at a “document station” remote from the user. This user may virtually write on the document by using an interactive whiteboard with an annotation subsystem. An image of the document, including actual writing and the virtual writing may be displayed at both stations. Advantageously the image(s) may be video images, but could be one or more still images. The station with the interactive whiteboard is referred to as the “virtual writing station.” The virtual writing station may be a personal computing platform having a video conferencing subsystem, an annotation subsystem, and a screen-sharing subsystem. A projector and interactive whiteboard at the virtual writing station may be used to project an image received over a communication link. The image may be displayed by the projector and the interactive whiteboard. The annotation subsystem may allow the user at the virtual writing station to annotate the image to create virtual writings on the image. The screen-sharing subsystem may be used to display a combination of the image of the document and the representation of the annotations to the second user at a document station remote from the virtual writing station.

The document station may have a personal computing device with a video conferencing subsystem, a screen-sharing subsystem, and a camera such as a document camera. Advantageously the camera is connected to the video conferencing subsystem. The document station may be configured to transfer the image(s) captured by the camera over a communications channel to the virtual writing station. The virtual writing system may be configured to display the annotations along with the received image and the screen-sharing subsystems are configured for the document system to display the image of the document with the annotations from the virtual writing station. Both stations may have one or more monitors or other display devices for displaying the document image, the annotations, the combination of document image and annotations, and/or a conventional video conference between users. Each station may have a conventional microphone, speaker, and video camera suitable for use in conventional video conferencing using the video conferencing subsystem or the screen-sharing subsystem.

The interactive whiteboard may be configured with the display/projection surface as a desktop surface emulating a piece of writing paper. At a minimum the interactive whiteboard should have the capability to display an image(s) and detect user input in relation to the displayed image(s). A projector may be used to effect the display. The user input detection may advantageously be accomplished using an infrared sensor and a stylus. A system configured with a stylus and an infrared sensor does not require a sophisticated projection surface. The projection surface may be composed of any platform material suitable for display of projected image(s) Annotation software may be utilized to translate user input, such as user interaction with the whiteboard into an image representation associated with the image displayed on the whiteboard. The annotations may be displayed by feedback to the interactive whiteboard projector and by screen-sharing to the document station. Both stations may also include video conferencing cameras, speakers, and microphones.

According to an advantageous feature, the users may selectively control the images and audio displayed on their own and/or the other station(s).

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

A clear understanding of the key features of the invention summarized above may be had by reference to the appended drawings, which, not necessarily drawn to scale, illustrate the method and system of the invention, although it will be understood that such drawings depict preferred embodiments of the invention and therefore are not to be considered as limiting its scope with regard to other embodiments which the invention is capable of contemplating. Accordingly:

FIG. 1 illustrates a schematic view of a first station, for example a student station according to an embodiment of the invention.

FIG. 2 illustrates a schematic view of a second station, for example an instructor station according to an embodiment of the invention.

### DETAILED DESCRIPTION OF THE PREFERRED EMBODIMENT

Various objects, features, aspects, and advantages of the present invention will become more apparent from the following detailed description of preferred embodiments of the invention, along with the accompanying drawings in which like numerals represent like components.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention.

According to an embodiment of the invention there may be a first station configured for use with a physical writing surface, such as paper.

According to an embodiment of the invention there may be a second station configured for a user remote from said first station to virtually “write” on said physical writing surface.

The first station may have a document camera directed toward a writing surface. The camera may image a document or object physically located at the first station. The first station may transmit an image(s) captured by the camera to a second station. The image capture and transmission may be video or still images.

The second station may include an interactive whiteboard. Such an interactive whiteboard has sensing capabilities to detect “writing” and may be associated with a projector and/or one or more displays. The projector may be arranged to cast an image(s) received from the first station onto a surface of the whiteboard. The interactive whiteboard may have a passive projection target such as a white foamboard. In this case remote sensing, such as with a stylus and infrared sensor, is required. In an alternate configuration, the interactive whiteboard may be a tablet with a touch screen display. A user at the second station may virtually write on the projection of the image received from the first station. The virtual writing may be added to the projection making it appear to a user at the second station that he is “writing” onto the image projected.

According to a feature of an embodiment of the invention a combination of the image transmitted to the second station and the virtual writing at the second station may be displayed on a monitor located at the first station.

The stations may also have audio and/or video conferencing capabilities for communications between the stations. In this way a user at a first station may experience a synchronous interaction with a user at a second station and have the user at the second station virtually write on paper at the first station.

According to an embodiment of the invention, the first station may be configured for use by a student and the second station may be configured for use by an instructor.

In one mode of operation a student at a first station may work with an instructor at the second station. The student can, for example, work a problem in pencil and paper at the first station and the instructor will be able to see and hear the student and speak to the student. The student may see and hear the instructor and speak to the instructor. Importantly, the instructor at the second station may see an image of the paper, or another image captured by a camera at the first station and virtually write on the image for display at the first station, and, if desired, display at the second station.

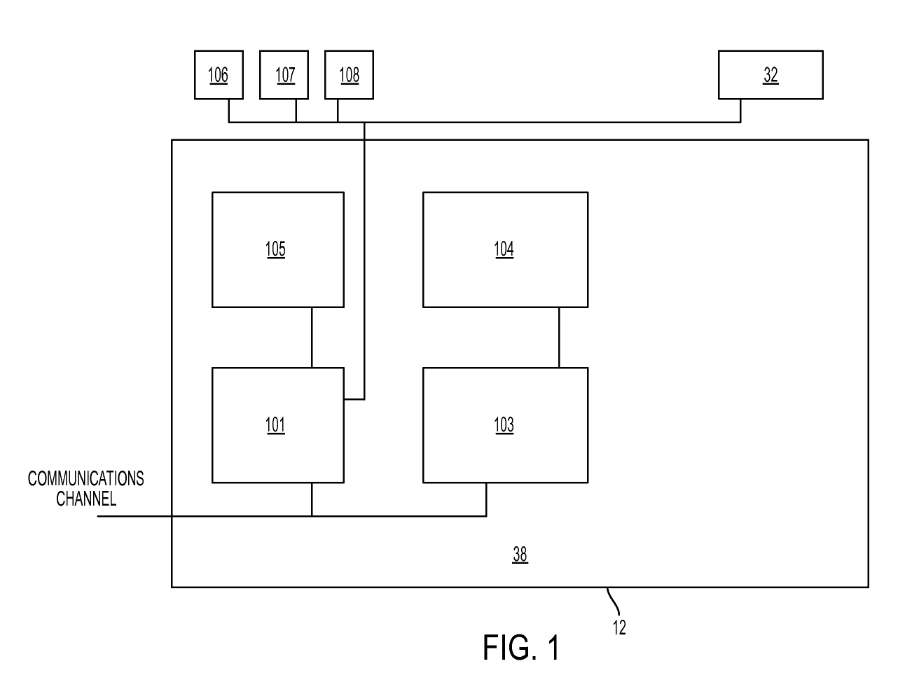

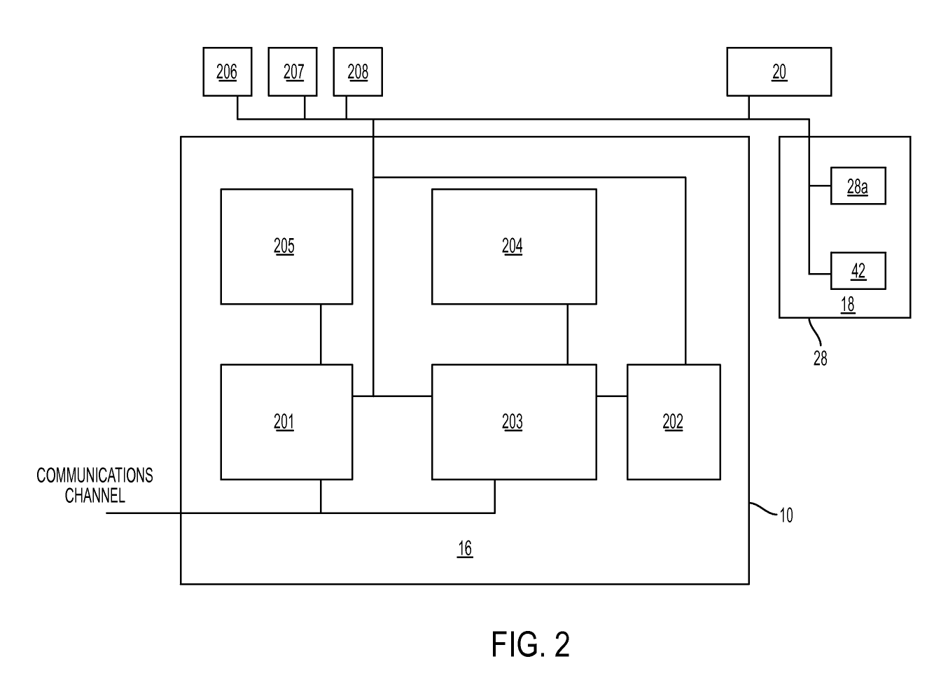

FIG. 1 illustrates a first station 12. FIG. 2 illustrates a second station 10. The first station 12 and second station 10 may be configured to allow online interactive instruction. The first station 12 and second station 10 may be remote from each other. Advantageously the first station 12 may be connected to the second station 10 by a communication link. The selection of the communication link is not essential to the invention. The communication link may, for example, be a LAN, WLAN, point-to-point, or Internet communication link. The second station 10 may include a computer 16. The computer 16 may be a Windows-based PC, an OS X based Mac (Apple) or other personal computing device. The second station 10 may also include a projection surface 18 which may be part of an interactive whiteboard system 28. A projector 20 may be connected to the computer 16. The projector 20 may be supported by a stand. An embodiment of the interactive whiteboard 28 may include a sensor 28a (e.g., an infrared sensor) that may be mounted to projector 20. The sensor 28a may advantageously be connected to the computer 16.

FIG. 1 shows a first station 12. Advantageously the first station may be a student station. The first station 12 may include a computer 38. The computer 38 may be a personal computing device such as a Mac or PC. The computer 38 may alternatively be any microprocessor-based computing platform with capabilities to handle screen sharing, conferencing, imaging, communications and networking. The computer 38 may be attached to a camera 32. Advantageously the camera 32 may be a document imaging camera and may be supported by a stand. The computer 38 may also include or be connected to an internal or external video camera 106, microphone 107, and speaker 108.

A videoconferencing subsystem 101 may transmit an image captured by camera 32 to the computer 16 of the second station 10. The image may be fed to projector 20 of the second station 10. The image projected by the projector 20 may be processed at the first station 12 by a video conferencing subsystem 101. The image may be received at the second station 10 and processed through the video conferencing subsystem 201. The projector 20 may cast a virtual representation of a book, paper, or other physical medium imaged by camera 32 connected to computer 38 of the first station 12. A user at the second station 10 may write virtually using a handheld device 42 (e.g., an infrared stylus) whose movements may be tracked by a sensor 28a. An annotation subsystem 202 on the second station 10 computer 16 may convert output from the sensor 28a into a representation of a visible image which may be sent to projector 20. The projector 20 may project the representation of the virtual writing together with the image received from camera 32 to display an image that gives the impression that a user of the second station 10 is writing on the book, paper, or other physical medium imaged at the first station 12.

A screen-sharing subsystem 203 may be part of computer 16 in the second station 10. A screen-sharing subsystem 103 may be part of the computer 38 of the first station 12. The screen-sharing subsystems 103 and 203 may be user-controlled and provide a representation of the virtual writing from the annotation subsystem 202 together with the image received through the video conference subsystem 101 from the camera 32 of the first station 12 by the computer 38 of the first station 12. In this manner the computer 38 may represent on a display 104 a combination of an image captured at the first station 12 by camera 32 with virtual writing added by the interactive whiteboard 28 of the second station 10.

The computer 38 of the first station 12 may also have a display 105 connected to the video conferencing subsystem 101 of the computer 38 of the first station 12. Display 104 and display 105 may be on one monitor or separate monitors. The video conference subsystem 101 of computer 38 of the first station 12 and video conference subsystem 201 of computer 16 of the second station 10 may be connected to respective display 105, camera 106, speaker 107, and microphone 108 of the first station 12 and display 205, camera 206, speaker 207, and microphone 208 for video conference interfacing.

The screen-sharing subsystem 203 of computer 16 of the second station 10 may allow a user of the second station 10 to select which images or applications to share with the first station 12.

When looking at display 104 and/or display 105 the user of the first station 12 is given the impression that the user of the second station 10 is present and able to write on the object or document that is being imaged at the first station 10 by camera 32 of the first station 12. Advantageously, the respective users are also able to interact by video conference subsystems 101 and 201 as if face-to face.

According to an embodiment of the invention, the illustrated elements may be implemented by using available components. The projector 20 may be of the type offered by AAXA Technologies, AAP300 Pico Projector. The projector 20 may be supported by a tripod microphone boom stand, Model MS 7701C offered by OnStage, and attached to said stand with OnStage CM01 Video Camera/Digital Recorder Adapter. The infrared sensor and stylus used in the interactive whiteboard 28 may be Model No. IS-01 offered by IPEVO. The camera 38 may be a high definition USB document camera such as Model CDVU-04IP, also available from IPEVO. The video conferencing subsystem 101, 201 may be Skype. The annotation subsystem 202 may be IPEVO Annotator which is included with the interactive whiteboard system Model No. IS-01. Adobe Connect is a powerful tool that can carry out at least a portion of the videoconferencing as well as the screen-sharing. The video conferencing subsystem 101, 201 may be implemented using Skype and/or Adobe Connect. The screen-share subsystems 103, 203 may advantageously be implemented with Adobe Connect. The subsystems 101, 102, 201, 202 and/or 203 may be implemented wholly or partially by a server or by the respective personal computing platforms. The respective displays at each station may be presented on one or more monitors and/or projectors. Those of ordinary skill in the art will recognize that the scope of the invention is not limited to these specific embodiments or components described herein. Other suitable or equivalent components maybe be utilized without departing from the spirit of the invention.

The construction details of the embodiments of the invention may be made of sufficiently rigid and strong material such as high-strength plastic, wood, metal, glass, and the like. Further, the various components of the system for interactive online instruction can be made of different materials appropriate for the uses described above.

The advantages of the present invention include, without limitation, the ability of an instructor to write virtually on a student's book, paper, or other physical medium, regardless of where the instructor and the student are located, as if the instructor were sitting with the student at the student's table.

Although the preceding description contains significant detail, it should not be construed as limiting the scope of the invention but rather as providing illustrations of the preferred embodiments of the invention. For example, although the preceding detailed description refers to the use of the present invention between one instructor and one student, it will be apparent to one of ordinary skill in the art that the present invention may be practiced without these specific limitations and that the present invention serves to allow one or more instructors to interact simultaneously with one or more students, as in a group or classroom setting.

Therefore, in broad embodiment, the present invention is a system for interactive online instruction that allows at least one instructor to write virtually on at least one student's book, paper, or other physical medium, regardless of where the instructor(s) and the student(s) are located, as if the instructor(s) were sitting with the student(s) at the same table or were otherwise collaborating with the student(s) on the same physical medium in the same physical classroom.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of educational technology have been disclosed. It should be apparent, however, to those skilled in the art that many more modifications besides those already described are possible without departing from the inventive concepts herein. The inventive subject matter, therefore, is not to be restricted except in the spirit of the disclosure.

What is claimed is:

1. A virtual writing station comprising:
a personal computing platform having a video conferencing subsystem, a first display associated with said video conferencing subsystem, an annotation subsystem, a screen-sharing subsystem associated with said annotation subsystem, and a second display associated with said screen-sharing subsystem;
an interactive whiteboard connected to said annotation subsystem; and
a projector connected to said personal computing platform;
wherein said personal computing platform is configured to receive an image over a communication link from a remote station, provide the image to said projector; transmit annotations generated from inputs from said interactive whiteboard to said remote station and combine said annotations and said image.

2. A virtual writing station according to claim 1 wherein said interactive whiteboard further comprises a virtual writing implement and a sensor detecting actions of said implement.

3. A virtual writing station according to claim 2 wherein said virtual writing implement is a stylus and said sensor is an infrared sensor.

4. A virtual writing station according to claim 1 wherein said screen-sharing subsystem is configured to combine and share said annotations and said image provided to said projector with a remote station.

5. A virtual writing station according to claim 1 wherein a personal computing platform is configured to provide said annotations to said projector.

6. A virtual writing station according to claim 5 further comprising a camera, a speaker, and a microphone connected to said video conferencing subsystem.

7. A virtual writing station according to claim 6 wherein said personal computing platform is configured to execute a video conferencing session and a screen-sharing session with a remote station.

8. A virtual writing system comprising:
a virtual writing station having:
a personal computing platform having a video conferencing subsystem;
a first display associated with said video conferencing subsystem;
an annotation subsystem;
a screen-sharing subsystem associated with said annotation subsystem; and
a second display associated with said screen-sharing subsystem;
an interactive whiteboard connected to said annotation subsystem;
and a projector connected to said personal computing platform;
wherein said personal computing platform is configured to receive an image over a communication link from a remote station, provide the image to said projector, transmit annotations generated from inputs from said interactive whiteboard to said remote station, and combine said annotations and said image;
a second station connected by a communication channel to said writing station wherein said second station is remote from said writing station and includes a remote personal computing device having a remote video conferencing subsystem, a remote screen-sharing subsystem and a second remote display linked to said remote screen-sharing subsystem;
a remote camera connected to said remote video conferencing subsystem;
wherein said remote personal computing device is configured to transmit one or more images captured by said remote camera from said remote video conferencing subsystem to said video conferencing subsystem of said virtual writing station; and said remote screen-sharing subsystem is configured to receive video information from said screen-sharing subsystem of said virtual writing system and display said video information on said second remote display.

9. A virtual writing system according to claim 8 wherein said second station further comprises a remote display connected to said remote video conferencing subsystem.

10. A virtual writing system according to claim 8 wherein said interactive whiteboard further comprises a virtual writing implement and a sensor detecting actions of said implement.

11. A virtual writing system according to claim 10 wherein said virtual writing implement is a stylus and said sensor is an infrared sensor.

12. A virtual writing system according to claim 8 wherein said screen-sharing subsystem is configured to combine and share said annotations and said image provided to said projector with a remote station.

13. A virtual writing system according to claim 8 wherein a personal computing platform is configured to provide said annotations to said projector.

14. A virtual writing system according to claim 13 further comprising a camera, a speaker, and a microphone connected to said video conferencing subsystem.

15. A virtual writing system according to claim 14 further comprising a remote camera, remote speaker and a remote microphone connected to said remote video conferencing subsystem.

16. A virtual writing system according to claim 15 wherein said personal computing platform is configured to execute a video conferencing session and a screen-sharing session with said second station.
